(19) United States
(12) Patent Application Publication
(10) Pub. No.: US 2018/0205834 A1
(43) Pub. Date: Jul. 19, 2018

(54) IMAGE FORMING APPARATUS THAT ADJUSTS POSITION OF IMAGE TO BE FORMED ON SHEET

(71) Applicant: CANON KABUSHIKI KAISHA, Tokyo (JP)

(72) Inventor: Yuuki Maeda, Nagareyama-shi (JP)

(21) Appl. No.: 15/866,992

(22) Filed: Jan. 10, 2018

(30) Foreign Application Priority Data
Jan. 13, 2017 (JP) 2017-004549

(51) Int. Cl. H04N 1/00; G03G 15/01; G03G 15/00; G03G 15/08

(52) U.S. Cl. CPC H04N 1/0066; G03G 15/0189; H04N 1/0057; G03G 15/0848; G03G 15/5058

(57) ABSTRACT

An image forming apparatus includes an image forming unit configured to form an image on a sheet, memory configured to store adjustment conditions for adjusting an image formation position by the image forming unit, as to the sheet, and a controller configured to control the image forming unit to form a test image on a plurality of sheets, acquire data relating to the test image formed on the plurality of sheets by the image forming unit, and generate the adjustment conditions based on the data. The test image is used to detect misalignment of images to be formed on the plurality of sheets. The controller controls a count of the plurality of sheets, based on data used in the past to generate adjustment conditions corresponding to the plurality of sheets.

### BACKGROUND OF THE INVENTION

### Field of the Invention

The present invention relates to printing position adjustment control, where an image formation position on a sheet is adjusted.

### Description of the Related Art

Image forming apparatuses commonly have a function of adjusting printing positions of images (hereinafter referred to as “printing position adjustment”), so that images are printed at intended positions on sheets. Adjusting the printing position enables high-quality printed matter to be provided, where printing positions of an image on a front face and an image on a back face are matched with high precision in duplex printing, for example. Also, in a cases of printing images on preprinted sheets that have been ruled beforehand or the like, for example, high-quality printed matter can be provided where printing has been performed such that the lines and images do not overlap.

This printing position adjustment needs to be executed for each type of sheet on which an image is printed. The reason is that the amount of stretching/shrinkage of sheets differs depending on the size, grammage (weight), material, etc., of the sheets.

Generally, printing position adjustment uses an adjustment chart created by printing marks on a sheet that is the object of adjustment. For example, the image forming apparatus detects the amount of misalignment of the printing position based on information regarding the length from a reference position in the adjustment chart to a mark, and decides correction conditions to correct the printing position based on the detection results. The image forming apparatus then corrects the printing position based on the correction conditions in a case of performing printing processing using sheets of the same type as the sheet that is the object here.

Now, it has been found that dimensions of sheets change depending on the moisture content of the sheets. For example, if images are printed using sheets of the same type that have been left to stand in environments with different humidity, the printing positions on the sheets will differ as a result. Generally, sheets used for printing are sold wrapped in wrapping paper to maintain the quality of the sheets. The wrapping paper has been subjected to special treatment so that the sheets do not absorb humidity, for example. An operator will unseal the wrapping paper and store the sheets in a storage portion in the image forming apparatus. Accordingly, the moisture content of the sheets may begin to change once the wrapping paper is unsealed.

Now, in a case of having stored the sheets removed from the wrapping paper in the storage portion of the image forming apparatus installed in a low-humidity room, the moisture content of the paper will drop over time. Accordingly, the dimensions of the sheets stored in the storage portion over a long period of time will shrink in comparison with sheets immediately after unsealing the wrapping paper. Alternatively, depending on the type of sheets, there are those where the dimensions of sheets stored in the storage portion for a long period of time will increase in comparison with the dimensions of the sheets immediately after unsealing.

Now, an image forming apparatus described in Japanese Patent Laid-Open No. 2005-221582 automatically performs printing position adjustment each time a predetermined amount of running time of the image forming apparatus elapses. The image forming apparatus according to Japanese Patent Laid-Open No. 2005-221582 has a timer, automatically prints a test sheet each time the running time of the image forming apparatus reaches a predetermined amount of time, conveys the test sheet to a reading sensor, and adjusts the printing position based on the results read from the test image on the test sheet.

Now, the sheets on which marks are formed have cutting error. Accordingly, the image forming apparatus creates multiple test sheets, for example, and adjusts the printing position based on the results of reading the multiple test sheets. However, there is a great likelihood that cutting error of sheets differs depending on the type of sheet and the like, so there is a problem that creating multiple test sheets regardless of the type of sheet results in more sheets being consumed. Further, a great number of test sheets means longer downtime due to the printing position adjustment.

### SUMMARY OF THE INVENTION

An image forming apparatus includes an image forming unit configured to form an image on a sheet, memory configured to store adjustment conditions for adjusting an image formation position by the image forming unit, as to the sheet, and a controller configured to control the image forming unit to form a test image on a plurality of sheets, acquire data relating to the test image formed on the plurality of sheets by the image forming unit, and generate the adjustment conditions based on the data. The test image is used to detect misalignment of images to be formed on the plurality of sheets. The controller controls a count of the plurality of sheets, based on data used in the past to generate adjustment conditions corresponding to the plurality of sheets.

Further features of the present invention will become apparent from the following description of exemplary embodiments with reference to the attached drawings.

### BRIEF DESCRIPTION OF THE DRAWINGS

FIG. 1 is a block diagram illustrating a hardware schematic configuration of a printing system.

FIG. 2 is a schematic diagram illustrating the configuration of an image forming unit.

FIG. 3 is a schematic diagram illustrating the configuration of a reading unit.

FIG. 4 is a schematic diagram of an interface screen for operating a sheet library.

FIG. 5 is a schematic diagram of an interface screen for editing sheet attributes.

FIG. 6 is an explanatory diagram of a sheet library.

FIG. 7 is a schematic diagram of an adjustment chart.

FIG. 8 is a schematic diagram for describing processing to find printing position misalignment amount.

FIG. 9 is a flowchart illustrating operations of the image forming apparatus.

FIG. 10 is a flowchart illustrating sheet count deciding processing.

FIGS. 11A and 11B are lists illustrating examples of adjustment amounts calculated from reading results for each sheet type.

FIG. 12 is a flowchart illustrating processing for deciding sheet count.

FIG. 13 is a schematic diagram illustrating a dialog screen for setting the output count of adjustment charts.

FIG. 14 is a schematic diagram illustrating an interface screen for an editor to edit sheet attributes.

FIG. 15 is a flowchart illustrating operations of the image forming apparatus.

FIG. 16 is a flowchart illustrating operations of the image forming apparatus.

FIG. 17 is a flowchart illustrating operations of the image forming apparatus.

FIG. 18 is a flowchart illustrating operations of the image forming apparatus.

### DESCRIPTION OF THE EMBODIMENTS

Embodiments for carrying out the present invention will be described below with reference to the drawings.

### Description of Printing System

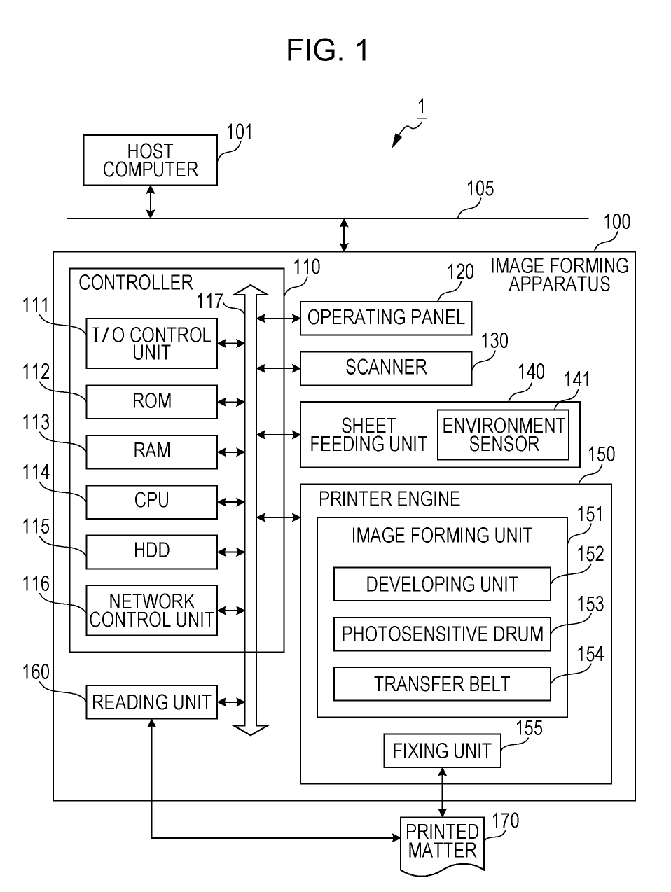

FIG. 1 is a block diagram illustrating a hardware systematic configuration of an embodiment of a printing system according to embodiments of the present invention. Note that unless specifically stated otherwise, embodiments of the present invention can be applied to a system in which connected processing is performed via a network such as a local area network (LAN), wide-area network (WAN), and the like. The printing system according to the present embodiment is configured including an image forming apparatus 100 and a host computer 101, as illustrated in FIG. 1. The image forming apparatus 100 and the host computer 101 are communicably connected by a network 105.

The host computer 101 acquires input information from a user by an input device that is omitted from illustration, creates a print job to be transmitted to the image forming apparatus 100, and transmits the created print job to the image forming apparatus 100. A controller 110 performs various types of data processing and controls the operations of the image forming apparatus 100. An operating panel 120 is a touch panel that accepts various operations performed by the user. A scanner 130 scans original documents and generates scanned image data. A sheet feeding unit 140 includes multiple storage portions for storing sheets. The sheet feeding unit 140 feeds sheets stored in the storage portions one at a time, and conveys the sheets to a printer engine 150. The printer engine 150 forms images on the printing sheets based on image data. Further, a reading unit 160 reads printed matter 170 printed by the printer engine 150, and transmits the reading results to the controller 110. The specific configuration of the reading unit 160 will be described later.

Next, the configuration of the controller 110 will be described. The controller 110, operating panel 120, scanner 130, sheet feeding unit 140, printer engine 150, and reading unit 160 are communicably connected with each other via a system bus 117. An I/O control unit 111 performs communication control regarding communication with an external network. Read-only memory (ROM) 112 is a storage medium that stores various types of control programs. Random access memory (RAM) 113 is system work memory. A central processing unit (CPU) 114 reads out control programs from the ROM 112, and executes the control programs using the RAM 113 as a work region. The CPU 114 centrally controls image signals and various types of devices. A hard disk drive (HDD) 115 performs temporary or long-term storage of great amounts of data, such as image data, print data, or the like. Control programs and an operating system are stored in the HDD 115 as well, besides the ROM 112. Further, non-volatile RAM (NVRAM) that is omitted from illustration may be provided, to store image forming apparatus mode setting information from the operating panel 120. A network control unit 116 is an interface that controls communication with other devices (host computer 101) via the network 105. The image forming apparatus 100 communicates with other devices via network by the network control unit 116.

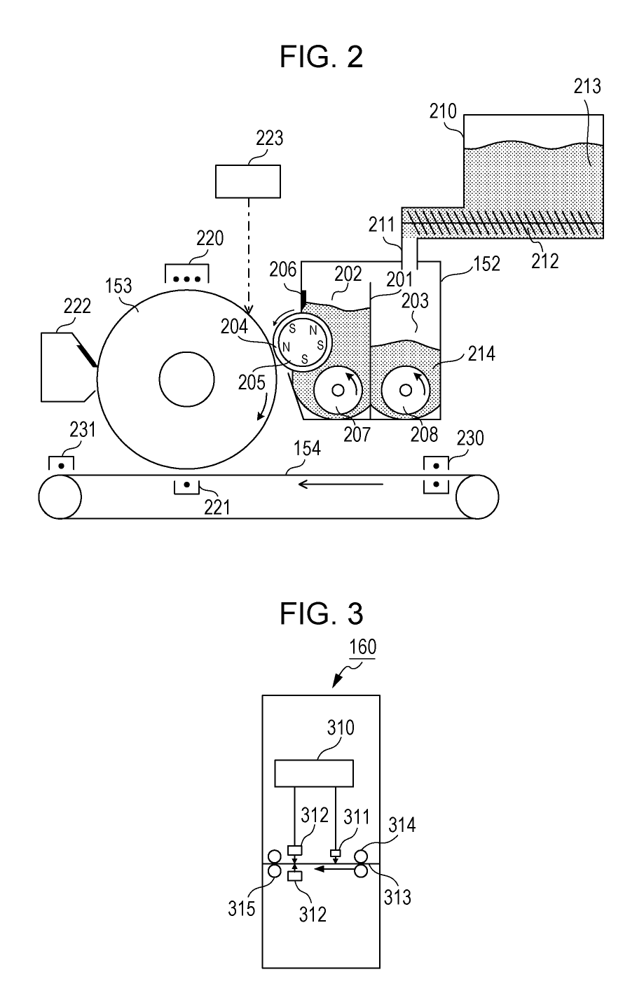

FIG. 2 is a cross-sectional view illustrating principal portions of an image forming unit 151. The image forming unit 151 forms a toner image on a photosensitive drum 153 using toner within a developing unit 152. Sheets fed from the sheet feeding unit 140 are conveyed to the photosensitive drum 153 by a transfer belt 154. The toner image on the photosensitive drum 153 is transferred onto the sheet conveyed by the transfer belt 154. The sheet onto which the toner image has been transferred is conveyed to a fixing unit 155 (FIG. 1). The fixing unit 155 (FIG. 1) heats and pressurizes the sheet onto which the toner image has been transferred, for example, thereby fixing the toner image onto the sheet. This completes printing of the image onto the sheet.

The photosensitive drum 153 is a drum-shaped image-bearing member that rotates on a drum axis in the direction of the arrow in FIG. 2. Disposed in the vicinity of the photosensitive drum 153 are a charger 220 that uniformly charges the surface of the photosensitive drum 153, the developing unit 152, a transfer charger 221 that transfers toner images to sheets, the transfer belt 154, and a drum cleaner 222. The image forming unit 151 also has an exposing device 223, whereby the surface of the photosensitive drum 153 between the charger 220 and the developing unit 152 is irradiated by a laser beam.

The exposing device 223 includes a semiconductor laser, a rotary polygonal mirror, a reflecting mirror, and so forth. The semiconductor laser emits a laser beam in accordance with image data. The laser beam emitted from the semiconductor laser is scanned over the photosensitive drum 153 in the drum axial direction by the reflecting mirror, the rotary polygonal mirror, and so forth. The exposing device 223 thus exposes the photosensitive drum 153, of which the surface has been uniformly charged by the charger 220, based on the image data transferred from the controller 110. Accordingly, an electrostatic latent image corresponding to the image data is formed on the surface of the photosensitive drum 153.

The developing unit 152 forms a toner image by developing the electrostatic latent image formed on the photosensitive drum 153. The inside of the developing unit 152 is sectioned into a developing chamber 202 and an agitation chamber 203 by a partition 201. The developing chamber 202 accommodates a two-component developer including toner and a magnetic carrier. Further, the developing unit 152 is provided with a developing sleeve 204 where magnets 205 are disposed and fixed, and a blade 206. The developing sleeve 204 bears the developer within developing chamber 202 by the magnetic force of the magnets 205. The blade 206 regulates the thickness of the layer of developer borne by the developing sleeve 204 to a predetermined thickness. The developing sleeve 204 conveys developer borne by itself to a developing position for developing the electrostatic latent image, by the developing sleeve 204 rotating. Thus, the electrostatic latent image formed on the photosensitive drum 153 is developed. Developing voltage is applied to the developing sleeve 204 by a power source unit that is omitted from illustration. Accordingly, potential difference is generated between the developing sleeve 204 and photosensitive drum 153. The toner in the developer borne by the developing sleeve 204 adheres to the electrostatic latent image on the photosensitive drum 153, thereby visualizing the electrostatic latent image.

The developing chamber 202 and agitation chamber 203 are provided with respective agitation screws 207 and 208. The agitation screws 207 and 208 cause frictional charge in the developer in the developing chamber 202 by agitating the developer in the developing chamber 202. The agitation screw 207 also functions to supply the developer within the developing chamber 202 to the developing sleeve 204. A toner replenishment tank 210 is connected to the agitation chamber 203, with toner 213 being supplied from the toner replenishment tank 210 via a toner discharge port 211. The agitation screw 208 agitates the toner 213 supplied to the agitation chamber 203 and the developer already within the developing unit 152. Thus, the toner concentration of the developer (the percentage by weight of toner as to the total weight of the developer) is made uniform.

Channels communicating between the developing chamber 202 and agitation chamber 203 are formed in the partition 201, at the front side and back side in FIG. 2. The concentration of toner in the two-component developer drops due to toner being consumed by developing. The two-component developer with lower toner concentration is conveyed from the developing chamber 202 to the agitation chamber 203 by the agitation screw 207 via one of the channels. The toner concentration of the two-component developer recovers in the, and this two-component developer is then conveyed from the agitation chamber 203 the to the developing chamber 202 by the agitation screw 208 via the other channel.

The transfer belt 154 is provided to come into close proximity with the photosensitive drum 153 between the developing unit 152 and drum cleaner 222. The transfer belt 154 is an endless belt that rotates in the counterclockwise direction in FIG. 2, and is stretched across rollers. The transfer charger 221 is provided at a position facing the photosensitive drum 153 across the transfer belt 154. An adsorption charger 230 is disposed across the transfer belt 154 at a position upstream from the transfer charger 221 in the rotational direction of the transfer belt 154. A discharging charger 231 is disposed at a position downstream from the transfer charger 221 in the rotational direction of the transfer belt 154.

A sheet fed from the sheet feeding unit 140 is conveyed to the transfer belt 154, and is electrostatically adsorbed to the transfer belt 154 by the adsorption charger 230. The sheet is conveyed by rotation of the transfer belt 154. When the sheet passes between the photosensitive drum 153 and the transfer charger 221, the toner image formed on the photosensitive drum 153 is transferred onto the sheet by the operation of the transfer charger 221. The sheet onto which the toner image has been transferred is conveyed by the transfer belt 154, and is separated from the transfer belt 154 by the discharging charger 231. After separation, the sheet is conveyed to the fixing unit 155 where the toner image is fixed. Note that residual toner on the photosensitive drum 153 after transfer of the toner image to the sheet is removed by the drum cleaner 222.

FIG. 3 is a configuration diagram of the reading unit 160. The reading unit 160 has a reading controller 310, a sheet detection sensor 311, and a line sensor 312. The reading unit 160 reads sheets on which test images (hereinafter referred to as “adjustment chart”) have been printed by the printer engine 150, while conveying along a conveyance path 313. Conveying rollers 314 and 315 function as a conveying unit that conveys sheets, on which adjustment charts have been printed, along the conveyance path 313. Adjustment charts will be described in detail later. Note that in the following description, a sheet on which an adjustment chart has been printed will be referred to as a “test sheet”.

The sheet detection sensor 311 is, for example, an optical sensor that has a light emitting portion and a photodetector. The sheet detection sensor 311 detects the leading edge in the conveyance direction of the test sheet being conveyed along the conveyance path 313. Multiple sheet detection sensors 311 are provided in a direction orthogonal to the conveyance direction of the sheet. The sheet detection sensors 311 each detect the leading edge of the sheet and notify the reading controller 310 of the detection timing of the leading edge. The reading controller 310 finds the amount of skewing of the sheet, based on the timings of the sheet detection sensors 311 detecting the leading edge of the sheet, and on the conveyance speed of the sheet.

The reading controller 310 controls the line sensor 312 to read the adjustment chart printed on the sheet. The adjustment chart is printed on both the front side and back side of the sheet, for example. Two line sensors 312 are provided, sandwiching the conveyance path 313, to read both sides of the sheet at once. The reading controller 310 transfers the skew angle of the sheet and the data read by the line sensors 312 to the controller 110. The controller 110 detects the printing position (image formation position) of the adjustment chart as to the sheet, based on the skew angle of the sheet and the read data.

### Sheet Library

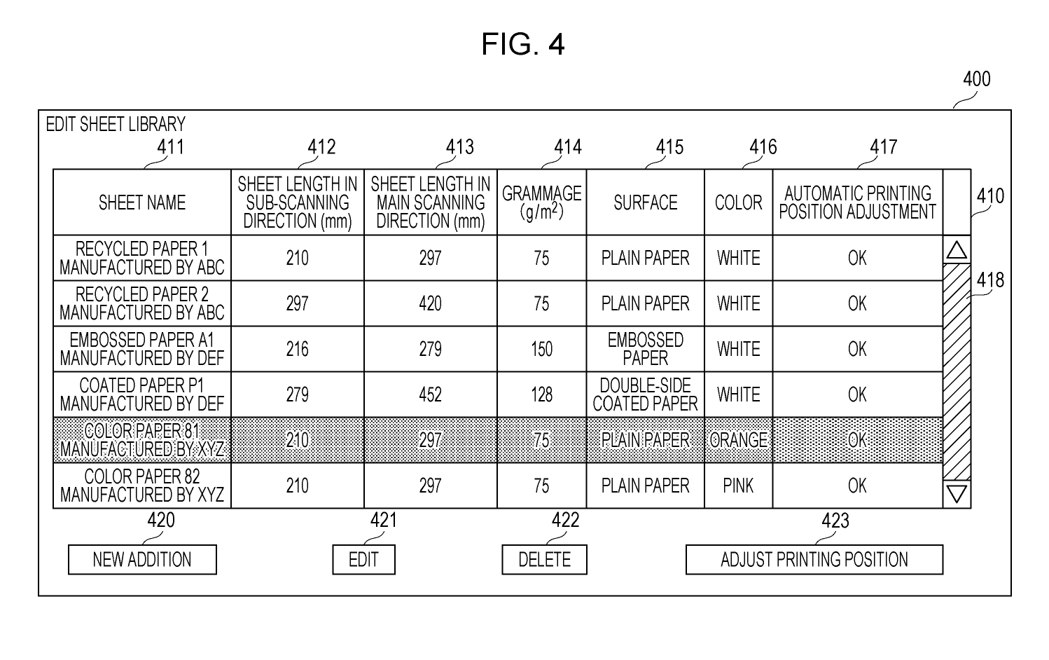

FIG. 4 is an exemplary diagram of an interface screen for performing operations such as editing or the like of a sheet library in the image forming apparatus 100 according to the present embodiment. The sheet library is a database for managing sheets that can be used for printing by the image forming apparatus 100. The sheet library is stored in the host computer 101 connected to the image forming apparatus 100 via network, for example. The sheet library will be described later in detail.

The interface screen for performing operations of the sheet library is displayed on the operating panel 120 of the image forming apparatus 100. An interface screen 400 includes a sheet list 410, a “new addition” button 420, an “edit” button 421, a “delete” button 422, and an “adjust printing position” button 423.

A list of sheets managed by the sheet library is displayed in the sheet list 410. Columns 411 through 417 display attribute information of sheets. Column 411 displays names of sheets. The names of sheets is information whereby the types of sheets can be distinguished from each other. Columns 412 and 413 display the sizes of sheets. Column 412 shows the length of the sheets in the direction in which the sheet is conveyed (sub-scanning direction), and column 412 shows the length of the sheets in a direction orthogonal to the direction in which the sheet is conveyed (main scanning direction). Column 414 shows the grammage of the sheets.

Column 415 shows information for the user to identify the surface of the sheets. Note that information for the user to identify the surface of the sheets is information relating to the physical properties of the surface of the sheet. For example, in a case where a sheet of which the surface has been treated to increase glossiness is registered in the sheet list 410, “coated” is displayed in column 415. In a case where a sheet, of which part has been physically raised as compared with the remainder, is registered in the sheet list 410, “embossed” is displayed in column 415. In a case where a sheet of which the surface has not been treated is registered in the sheet list 410, “plain paper” is displayed in column 415.

Column 416 shows the color of the sheets. Column 417 shows information for instructing automatic execution of printing position adjustment. “Ok” is shown in column 417 corresponding to sheets regarding which the user has executed printing position adjustment. When a sheet where “Ok” is displayed in column 417 is registered in the sheet library, the image forming apparatus 100 accordingly uses corresponding sheets from the sheet feeding unit 140 to execute printing position adjustment.

The user can select a sheet displayed in the sheet list 410 by a touch operation or the like on the operating panel 120. The attributes of the sheet that has been selected are highlighted to facilitate recognition. An example where “color paper 81 manufactured by XYZ” has been selected is illustrated here. In a case where the number of types of sheets managed by the sheet library is greater than can be displayed on the sheet list 410 at once, the sheets attributes can be displayed and selected by operating a scroll bar 418.

The “new addition” button 420 is a button used to add a new sheet to the sheet library. The “edit” button 421 is a button used to edit sheet attributes of a sheet selected in the sheet list 410. The “delete” button 422 is a button used to delete a sheet selected in the sheet list 410 from the sheet library. The “adjust printing position” button 423 is a button used to perform printing position adjustment regarding a sheet selected by the user from the sheet list 410.

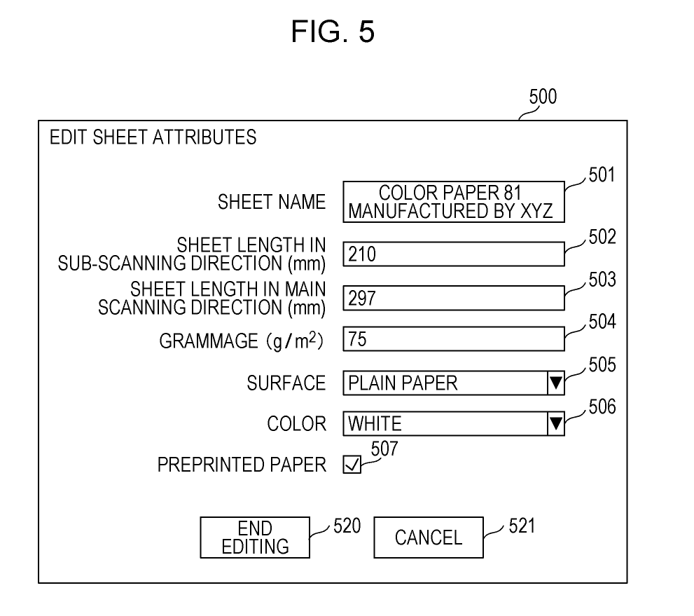

Pressing the “new addition” button 420 or the “edit” button 421 brings up an interface screen in the operating panel 120 of the image forming apparatus 100, for inputting sheet attributes. The interface screen for inputting sheet attributes will be described with reference to FIG. 5. An interface screen 500 has text boxes 501 through 504, combo boxes 505 and 506, a checkbox 507, an “end editing” button 520, and a “cancel” button 521.

Textbox 501 is an input region for the name of the sheet. Textbox 502 is an input region for the length of the sheet in the sub-scanning direction of the sheet (sheet length in sub-scanning direction). Textbox 503 is an input region for the length of the sheet in the main scanning direction of the sheet (sheet length in main scanning direction). Textbox 504 is an input region for the grammage of the sheet. Input to the textboxes 501 through 504 is performed by input keys provided to the operating panel 120. Alternatively, a configuration may be made where information is input to the textboxes 501 through 504 from an external device such as a personal computer (PC), for example.

The combo box 505 is an input region for inputting the surface of the sheet. The user uses the combo box 505 to specify one from a pull-down list of preregistered sheet surfaces that can be used in the image forming apparatus 100. The combo box 506 is an input region for inputting the color of the sheet. The user uses the combo box 506 to specify one from a pull-down list of preregistered colors.

Checkbox 507 is an input region for specifying whether or not the sheet is preprinted paper. In a case where the sheet is preprinted paper, the operator checks the checkbox 507.

Pressing the “end editing” button 520 finalizes the sheet attributes input up to that point. The controller 110 saves information relating to the sheet attributes in the sheet library. After the sheet attributes have been saved in the sheet library, the interface screen 500 is switched to the interface screen 400 in FIG. 4. Pressing the “cancel” button 521 cancels editing of sheet attributes. By pressing the “cancel” button 521, the interface screen 500 is switched to the interface screen 400 in FIG. 4 without saving the sheet attributes to the sheet library.

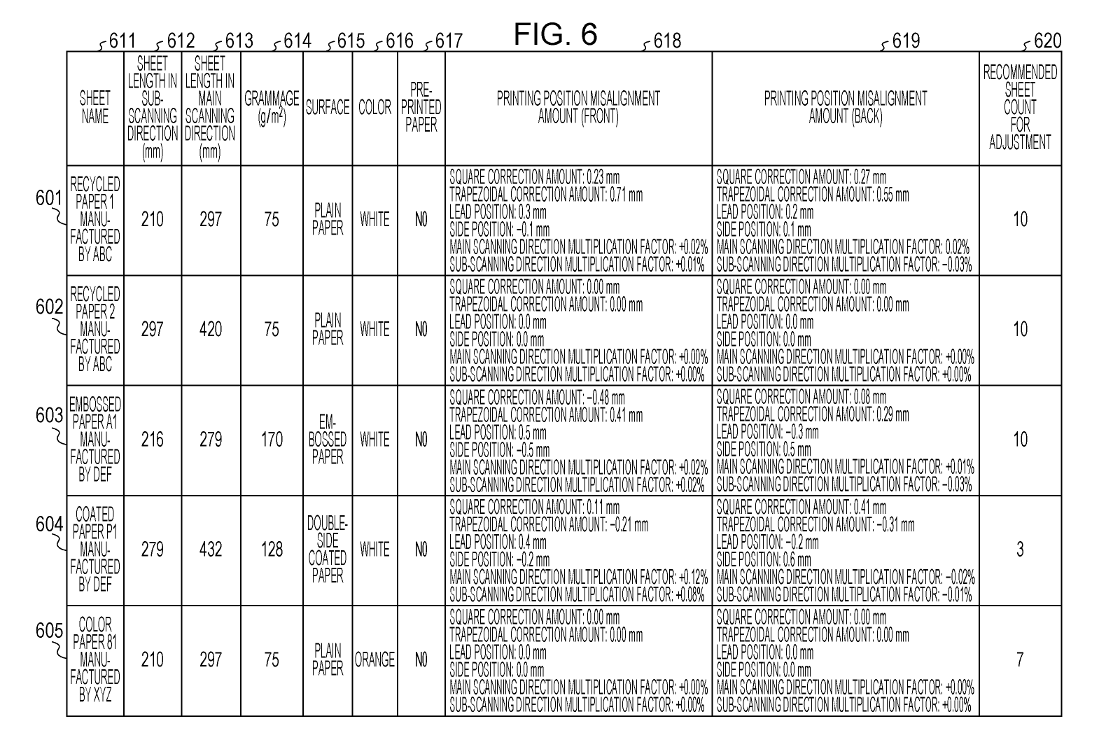

FIG. 6 is an explanatory diagram of the sheet library. The sheet library is stored in the HDD 115 of the image forming apparatus 100 in a file format such as Extensible Markup Language (XML), Comma-separated Values (CVS), or the like, for example. The controller 110 performs processing such as reading from, writing to, or updating of, the sheet library.

Rows 601 through 605 are information relating to each of the sheet types registered in the sheet library (attribute information). Columns 611 through 620 represent the items of attribute information. Column 611 shows the names of the sheets. Columns 612 through 615 show the physical properties of the sheets. Column 612 shows the sheet length in the sub-scanning direction, column 613 shows the sheet length in the main scanning direction, column 614 shows the grammage, and column 615 shows the surface of the sheets. Column 616 shows the color of the sheets. Column 617 indicates whether the sheets are preprinted paper.

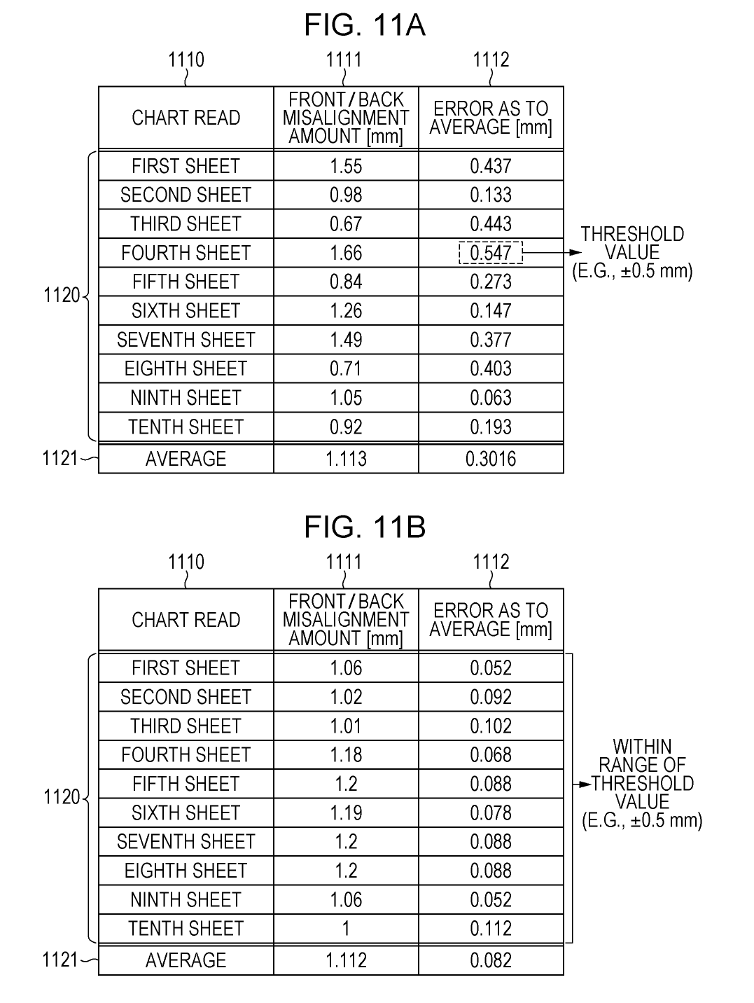

Columns 618 and 619 show the printing misalignment amounts at the front side and back side of the sheets. The printing misalignment amount is a value quantitatively indicating the amount of deviation from an ideal printing region exhibited by a predicted printing region predicted from the results of reading a test image. Note that an ideal printing region is a rectangle having four sides of predetermined lengths, where one side of the printing region is parallel to a predetermined side of the sheet, and the distance between the predetermined side of the sheet and one side of the printing region parallel to this predetermined side is a predetermined distance. An example of an adjustment chart will be described later with reference to FIGS. 11A and 11B.

The printing misalignment amounts are expressed by parameter such as square correction amount, trapezoidal correction amount, lead position, side position, main scanning multiplication factor, and sub-scanning multiplication factor, for example. Square correction amount indicates the amount of deviation regarding the degree of squareness of the direction of printing in the sub-scanning direction and main scanning direction as to the sheet. For example, the square correction amount is an amount of deviation obtained by calculating an ideal perpendicular line as to a straight line printed in the sub-scanning direction, and finding the amount of deviation of a straight line printed in the main scanning direction as to that ideal perpendicular line. Trapezoidal correction amount indicates the amount of deviation due to stretching/shrinkage of the sheets. For example, trapezoidal correction amount is the amount of deviation between a straight line printed in the sub-scanning direction from a printing start position on a sheet to the rear end of the sub-scan, and a straight line printed in the sub-scanning direction from a position at the rear end of a main scan on the sheet to the rear end of the sub-scan. The lead position and side position respectively indicate the printing position misalignment amounts as to the sheet in the sub-scanning direction and main scanning direction.

The lead position is adjusted by changing the printing start position of the image, with the front-end edge of the sheet in the conveyance direction as the start point. The side position is adjusted by changing the printing start position of the image, with the left-end edge of the sheet in the conveyance direction as the start point. Specifically, the irradiation start timing of the photosensitive drum 153 being irradiated by a laser beam by the exposing device 223 is adjusted, thereby adjusting the lead position and the side position. For example, the CPU 114 controls the exposing device 223 and adjusts the irradiation start timing of the laser beam.

The sub-scanning multiplication factor indicates image-length deviation in the sub-scanning direction (multiplication factor as to the ideal length). Specifically, this is adjusted by controlling the rotational speed of the transfer belt 154. For example, the CPU 114 adjusts the rotational speed of a motor (omitted from illustration) that rotates the transfer belt 154. The main scanning multiplication factor indicates image-length deviation in the main scanning direction (multiplication factor as to the ideal length). Specifically, this is adjusted by controlling the clock frequency of the laser beam when modulating the laser beam based on image data at the exposing device 223. For example, The CPU 114 controls the exposing device 223 to control the clock frequency. Alternatively, an arrangement may be made where the CPU 114 subjects the image data to image processing so that the printing position of the output image is at the ideal printing position. An example of image processing performed so that the printing position of the output image is at the ideal printing position is image processing such as affine transform.

The controller 110 adjusts the printing position so that the output image is formed at the ideal printing position when actually printing, based on the printing position misalignment amount. The controller 110 references the printing position misalignment amount in the sheet library and subjects the image data to image processing so that the printing position is the ideal printing position. The controller 110 then transfers the image data that has been subjected to image processing to the printer engine 150, where the image forming unit 151 is controlled to print the image on the relevant sheet based on the image data.

The default value for each item in the printing position misalignment amount is “0”. The default value is used as the printing position misalignment amount in cases where a sheet is newly registered in the sheet library, and cases where a sheet has been registered but printing position adjustment has not been performed.

Further, a column 620 is provided in the present embodiment, indicating the recommended number of adjustment charts to be output at the time of correcting printing position misalignment. Adjustment charts need to be printed in order to calculate the printing position misalignment amount stored in columns 618 and 619, as described above. However, the printing position misalignment amount is affected by the hygroscopicity and sheet size of the sheets on which the adjustment chart is printed. The sheet size of each sheet is normally thought to be the same, but in reality, there is variability in size from one sheet to another, although slight. This is because sheets of a certain size are manufactured by cutting paper of a larger size. Even when cutting sheets of the same size, there is variability of several hundredths of a millimeter up to several millimeters, depending on the precision of the paper cutting machine. Accordingly, the controller 110 outputs multiple adjustment charts and obtains an average value for the printing position misalignment amount, in order to suppress variability in printing position misalignment correction amount. Thus, depending on the type of sheet, there are sheets where the cutting variability is negligible, and there are sheets where the cutting variability is not negligible, so the controller 110 sets the recommended output sheet count of test charts for each sheet type, so that sufficient precision compensation can be realized when performing printing position adjustment. The method of deciding the recommended output sheet count for adjustment test charts will be described later in detail with reference to the flowcharts.

### Printing Position Adjustment

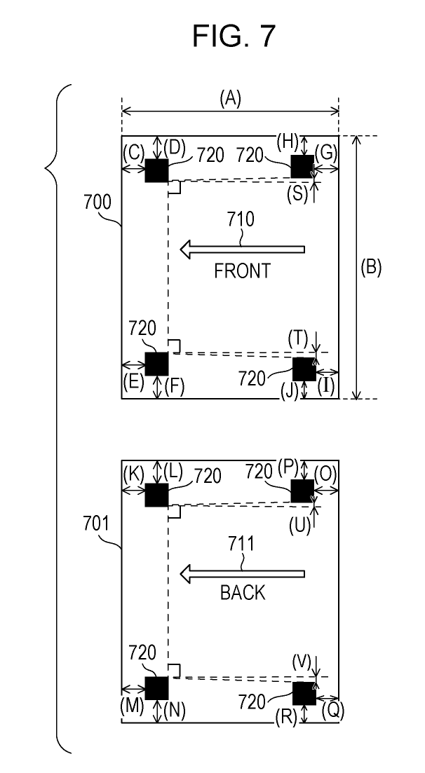

FIG. 7 is a schematic diagram of a test sheet. The adjustment chart on the test sheet is printed on the sheet by the printer engine 150. The same adjustment chart is printed on the front side 700 and the back side 701 of the sheet.

An image 710 is text and an arrow printed on the front face 700, and is used for identifying the conveyance direction and the front/back of the test sheet. An image 711 is text and an arrow printed on the back face 701, and is used for identifying the conveyance direction and the front/back of the test sheet. The images 710 and 711 are printed such that the operator will not mistake the direction when causing the reading unit 160 to read the test sheet. Note that the images 710 and 711 do not directly relate to finding the printing position misalignment amount, and accordingly do not have to be printed.

A mark 720 is an image printed at a particular position in the adjustment chart. The mark 720 is formed using a color that has a great difference in reflectivity as to the sheet. The mark 720 is formed using black in the present embodiment. A total of eight marks 720 are formed in the present embodiment, at the four corners of each of the front face 700 and back face 701 of the sheet. If the printing position is ideal, the marks 720 will be formed at positions that are predetermined distances from the edges of the sheet. The printing position misalignment amount can be found by finding the distances from the edges of the test sheet to the edges of the marks 720. Distances A through V in FIG. 7 are measured in the present embodiment. Distance A is the length of the test sheet in the sub-scanning direction. Distance B is the length of the test sheet in the main scanning direction. The ideal lengths for distances A and B are the sheet lengths set in the sheet library. Distances C through V are lengths from the respective marks 720 to the closest edges of the sheet.

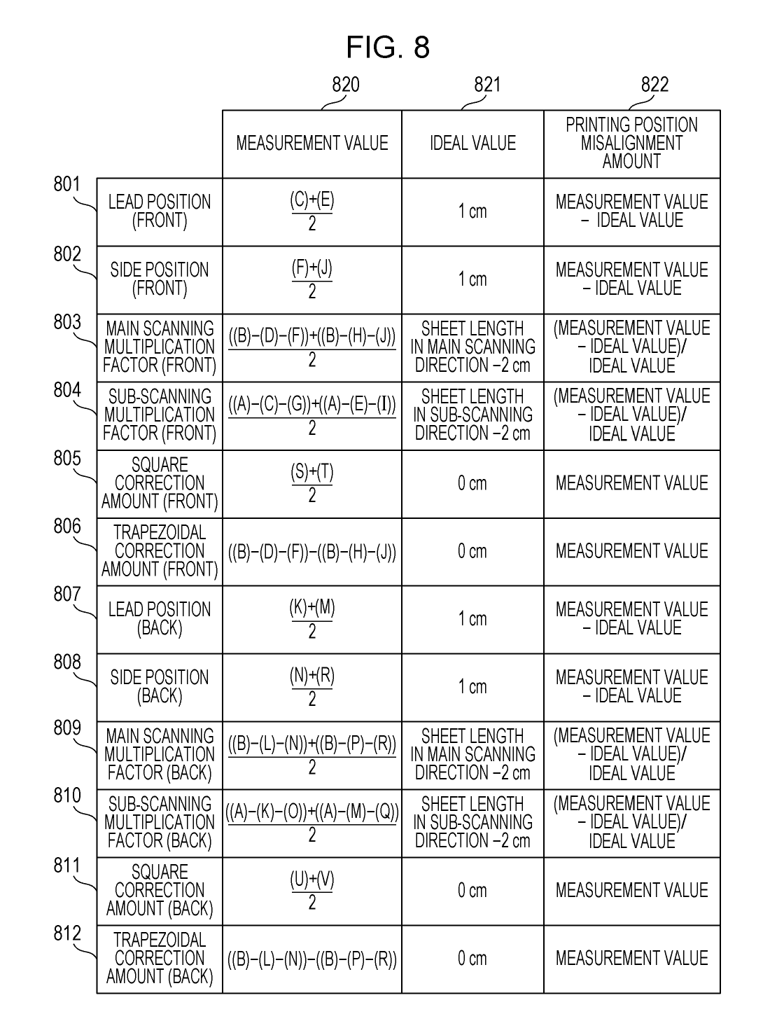

Processing for finding the printing position misalignment amount based on the measured distances A through V will be described. FIG. 8 is an explanatory diagram of printing position misalignment amount detection processing.

The printing position misalignment amount is indicated by items for the front face and items for the back face. Items for the front face are lead position 801, side position 802, main scanning multiplication factor 803, sub-scanning multiplication factor 804, square correction amount 805, and trapezoidal correction amount 806. Items for the back face are lead position 807, side position 808, main scanning multiplication factor 809, sub-scanning multiplication factor 810, square correction amount 811, and trapezoidal correction amount 812. A measurement value 820 and printing position misalignment amount 822 are calculated for each of the front face and back face for items that are the same, using the same calculation expression, and the same ideal values are set.

The measurement values 820 for these items are calculated according to a calculation expression set for each item, from the actually-measured values of distances A through V described in FIG. 7. The measurement value 820 for lead position 801 (807) is the average value of distances C and E (K and M) from the front-end edge of the sheet in the conveyance direction to the corresponding marks 720. The measurement value 820 for side position 802 (808) is the average value of distances F and J (N and R) from the left-end edge of the sheet in the conveyance direction to the corresponding marks 720. The measurement value 820 for main scanning multiplication factor 803 (809) is the average value of distances between marks 720 arrayed in a straight line in the main scanning direction. The measurement value 820 for sub-scanning multiplication factor 804 (810) is the average value of distances between marks 720 arrayed in a straight line in the sub-scanning direction. The measurement value 820 for square correction amount 805 (811) is the average value of sub-scanning direction misalignment amounts S and T (U and V) of marks 720 at the reading trailing edge side, as to a straight perpendicular line connecting marks 720 arrayed on the same scanning line in the main scanning direction at the reading leading edge side. The measurement value 820 for trapezoidal correction amount 806 (812) is the difference in distances between marks 720 arrayed on the same scanning line in the sub-scanning direction.

The ideal value 821 for each item is a value obtained based on marks 720 formed at positions 1 cm from the edges of the sheet. The ideal value 821 for lead position 801 (807) and side position 802 (808) is 1 cm. The ideal value 821 for main scanning multiplication factor 803 (809) is a value obtained by subtracting 2 cm from the sheet length in the main scanning direction of the sheet that has been registered in the sheet library. The ideal value 821 for sub-scanning multiplication factor 804 (810) is a value obtained by subtracting 2 cm from the sheet length in the sub-scanning direction of the sheet that has been registered in the sheet library. The ideal value 821 of the square correction amount 805 (811) and trapezoidal correction amount 806 (812) is 0 cm.

The printing position misalignment amount 822 of each item is calculated from the corresponding measurement value 820 and ideal value 821 using a calculation expression set for each item. The printing position misalignment amount 822 of the lead position 801 (807) and side position 802 (808) is calculated by subtracting the ideal value 821 from the measurement value 820. The unit for these amounts is millimeters. The printing position misalignment amount 822 of the main scanning multiplication factor 803 (809) and sub-scanning multiplication factor 804 (810) is calculated by dividing a value, obtained by subtracting the ideal value 821 from the measurement value 820, by the ideal value 821. The unit for these amounts is percent. The printing position misalignment amount 822 of the square correction amount 805 (811) and trapezoidal correction amount 806 (812) is the measurement value 820, used as it is. The printing position misalignment amount 822 calculated for each item is managed by the columns 618 and 619 in the sheet library.

Distances A through V can be obtained by measurement by the operator using a ruler or the like, or calculated from results of reading the test sheet by the scanner 130. A method of measuring the distances A through V using the reading unit 160 provided to the image forming apparatus 100 will be described in the present embodiment.

The reading unit 160 reads the adjustment chart on the test sheet. The reading unit 160 scans the test sheet conveyed along the conveyance path 313 using the line sensor 312. The marks 720 on the test sheet have been formed using back toner. Accordingly, the amount of reflected light received by the line sensor 312 is smaller than a predetermined amount. On the other hand, the sheet is white for example, so the amount of reflected light received by the line sensor 312 is greater than the predetermined amount. The reading unit 160 analyzes the read image obtained by scanning and detects edges of the marks 720 (boundaries between the sheet color portion and the marks 720). The controller 110 calculates the distances C through V from the edges of the sheet to the edges of the marks 720, based on the reading results of the reading unit 160.

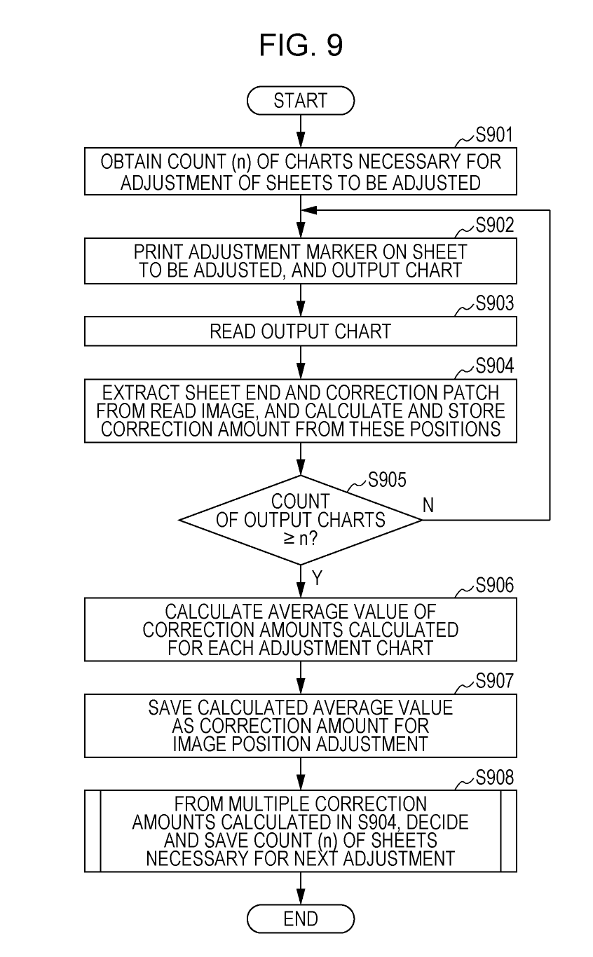

A control flow of calculating the correction amount of the printing position, by image analysis from an image scanned by the reading unit 160, will be described in detail below with reference to FIG. 9. Control, which is a feature of the present embodiment, regarding printing position adjustment performed by the CPU 114, to realize printing position adjustment for each sheet by the image forming apparatus, reading unit, and calculation method described in FIGS. 1 through 8, will be described in detail with reference to FIGS. 9 through 12. In the control in the steps of the flowcharts below, various types of operations are realized by the CPU 114 reading out and executing programs from the ROM 112. The operator selects one sheet from the interface screen 400 illustrated in FIG. 4 and presses the “adjust printing position” button 423 to cause the image forming apparatus 100 to execute printing position adjustment. Alternatively, a configuration may be made where the controller 110 automatically executes printing position adjustment upon a predetermined amount of time having elapsed from the previous time of printing position adjustment having been executed.

In S901, the CPU 114 obtains a chart count (n) necessary to perform printing position adjustment, from sheet library information regarding the sheet selected by the operator. The flow then advances to S902. Although a configuration is described here where the number of adjustment charts when performing printing position adjustment is automatically obtained from the sheet library information, this is not restrictive, and a configuration may be made where the operator inputs information relating to the number of adjustment charts from the operating panel 120 every time.

The CPU 114 identifies in S902 the storage portion containing the sheet selected by the user, causes the sheet feeding unit 140 to feed a sheet from the identified storage portion, and causes the printer engine 150 to print an adjustment chart. Next, in S903, the CPU 114 causes the reading unit 160 to read the adjustment chart that has been output, and in S904 extracts the edges and marks based on the read image and obtains the lengths of the portions indicated by A through V in FIG. 7. The CPU 114 calculates each correction amount based on the calculation expressions in FIG. 8 in S904, and stores the correction amounts in the HDD 115. In S905, the CPU 114 determines whether or not the number of charts output and read has reached the count (n) set in S901. In a case where the count necessary for adjustment has not been reached, the flow returns to S902.

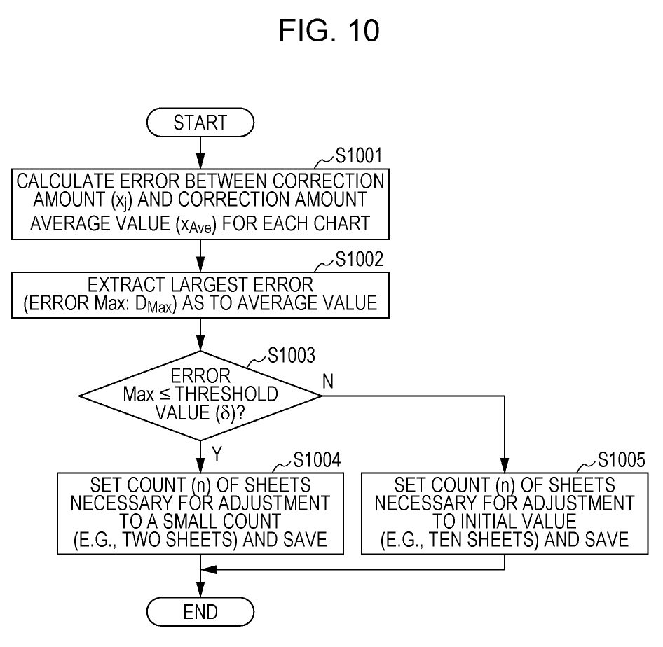

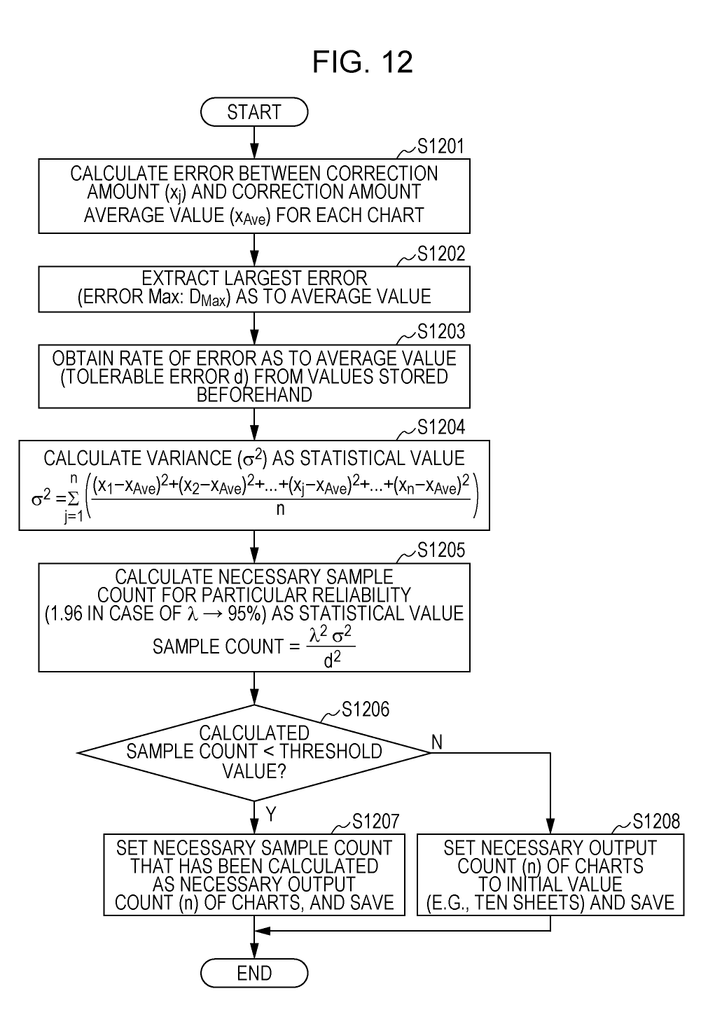

On the other hand, in a case where determination is made in S905 that the necessary number has been read, in S906 the CPU 114 calculates the average values of each correction amount stored in the HDD 115. Next, in S907, the CPU 114 saves the average values calculated in S906 in the sheet library in HDD 115, as the correction amounts for printing position adjustment of the sheet selected from the interface screen 400. Then, in S908, the CPU 114 calculates a statistical value for the correction amounts, decides the number of charts necessary for printing position adjustment the next time based on the statistical value, saves the number of charts in the sheet library, and ends the flow. The processing for deciding the number of charts necessary for adjustment the next time, based on the statistical value for the correction amounts, will be described in detail with reference to FIGS. 10 and 12.

The CPU 114 calculates in S1001 the difference between the correction amount for each chart stored in the HDD 115 in S904, and the average value calculated in S906. The CPU 114 detects the variability in printing position adjustment amount according to the size of the sheet selected from the interface screen 400 (FIGS. 11A and 11B illustrate examples of variation). Although description has been made that error is calculated from the printing position correction amount stored in the HDD 115 in S904, an arrangement may be made where, for example, the correction amount first output after sheet registration is used. Alternatively, the correction amount at the time of having output the same number of sheets as the default value for the number of sheets necessary for adjustment (e.g., ten) may be used.

In S1002, the CPU 114 extracts, out of the errors, the error that is the greatest, i.e., the farthest from the average of correction amounts of adjustment charts calculated in S1001. The CPU 114 then, in S1003, determines whether or not the greatest error from the average that has been extracted in S1002 exceeds a threshold value. In a case where the greatest error does not exceed the threshold value in S1003, the CPU 114 advances to S1004. In a case where the greatest error exceeds the threshold value in S1003, the CPU 114 advances to S1005. The processing in S1003 is processing to determine whether the sheet selected from the interface screen 400 is a sheet that has great variability in correction amounts from one sheet to another. This threshold value is set assuming a system where a range (±S) that ensures the printing position precision of the image forming apparatus stored in the HDD 115 beforehand as the range of error, but this is not restrictive. For example, a configuration may be made where the operator can input a range of error that is tolerable from the operating panel 120. Further, a configuration may be made where this threshold value is not only held as a unique value for the device, but also can be stored beforehand for each sheet type, or input by the operator.

In S1004, the CPU 114 determines that the sheet is a sheet type where variability among the multiple charts read this time is small, and sets the number of sheets necessary for adjustment to two, for example. The output count information is saved in the sheet library information. Note that the method of deciding the output count is fixing to a predetermined count, but this is not restrictive. An arrangement may be made where the operator can input a minimum count beforehand. Alternatively, an arrangement may be made where control is performed to use a calculation expression where the count is reduced (e.g., a method where the count is decremented by one each time, or a method where the output count is halved each time) beforehand.

In S1005, the CPU 114 determines that the sheet is a sheet type where variability among the multiple charts read this time is great, changes the number of sheets necessary for adjustment to the default value (e.g., ten) and updates the sheet library information, and ends the flow. Although an arrangement has been described in the present embodiment where control is performed to calculate the recommended count of test charts for the next time each time multiple charts are output, this is not restrictive. An arrangement may be made in which the CPU 114 performs control where the flow illustrated in FIG. 10 is executed just once after sheet registration, and the recommended count is decided.

According to this control, the number of adjustment charts output can be suppressed while suppressing variability in printing position misalignment due to variability in cutting of the sheets. Thus, unnecessary consumption of sheets and toner can be suppressed, and further the amount of time spent on printing position adjustment can be reduced.

FIGS. 11A and 11B are tables illustrating examples of variability of correction amounts depending on the sheet. The tables show correction amounts of sheets that have equivalent printing position adjustment amounts determined by hygroscopic properties thereof. The printing position misalignment amounts (front-to-back misalignment amounts) differ sheet to sheet. Column 1110 indicates the No. in order of the read chart. Column 1111 indicates the misalignment amount of the lead position. Column 1112 indicates the error from an average value 1121 of printing position misalignment amounts. In the examples in FIGS. 11A and 11B, the front-to-back lead position misalignment amount is around 1.11 millimeters for both sheets A and B. However, the variability among individual sheets is extremely small for sheet B. Accordingly, the cutting error in sheet size among individual sheets is assumed to be extremely small for sheet B, and determination can be made that the chart output and reading count to suppress error due to cutting variability can be small.

Thus, the CPU 114 decides the average value of printing position misalignment amounts based on results of reading multiple test sheets, obtains a greatest misalignment amount from printing position misalignment amounts of multiple test sheets, and if the greatest misalignment amount is smaller than a threshold value, reduces the recommended count. On the other hand, if the greatest misalignment amount is greater than the threshold value, the CPU 114 sets the recommended count to a predetermined number. According to embodiments of the present invention, cutting error of sheets can be obtained from reading results of test charts, and in a case where the cutting error is minute, the number of test chart output count can be reduced to suppress consumption of sheets. Further, the test chart output count is reduced according to embodiments of the present invention, so downtime due to printing position adjustment being performed can also be suppressed.

FIG. 12 is a modification of count deciding processing where the number of charts necessary for adjustment is decided in S908. The count deciding processing illustrated in FIG. 12 uses a statistical technique, unlike the count deciding processing using a threshold value (FIG. 10).

S1201 and S1202 are the same control as S1001 and S1002, so description will be omitted. In S1203, the CPU 114 acquires a rate of occurrence of error as to an average value (tolerable error d) from the HDD 115. Note that this tolerable error may be a fixed value set beforehand from statistical empirical rule (e.g., around 10%). Alternatively, the tolerable error may be calculated from a range (±δ) that ensures the printing position precision of the image forming apparatus, and the average (X_{Ave}) Of printing position misalignment amounts. Specifically, the tolerable error may be calculated by the following calculation Expression (1).

$$d = \frac{δ}{{x}_{Ave}} \qquad ( 1 )$$

Next, in step S1204, the CPU 114 uses the following Expression (2) to calculate variance (σ²) as a statistical value using the correction amounts calculated in S904 and the average value calculated in S906, and advances to S1205.

$${σ}^{2} = {\sum }_{j = 1}^{n} ( \frac{\begin{matrix}{( {x}_{1} - {x}_{Ave} )}^{2} + {( {x}_{2} - {x}_{Ave} )}^{2} + … + \\ {( {x}_{j} - {x}_{Ave} )}^{2} + … + {( {x}_{n} - {x}_{Ave} )}^{2}\end{matrix}}{n} ) \qquad ( 2 )$$

In S1205, the CPU 114 calculates the necessary sample count using the tolerable error (d) calculated in S1203 and the variance (σ²) calculated in S1204, and advances to S1206. Note that λ is a coefficient for a particular reliability (1.96 in a case of reliability of (λ→95%).

$$sample count = \frac{{λ}^{2} {σ}^{2}}{{d}^{2}} \qquad ( 3 )$$

In S1206, the CPU 114 determines whether or not the calculated sample count is within the range of the threshold value, and if so advances to S1207, but if otherwise, to S1208. Now, this threshold value in the present embodiment has been assumed to be the maximum value of the necessary chart output count (i.e., around ten, which is the default value), but this is not restrictive, and a configuration may be made where the user decides the output count by manual input. In S1207, the CPU 114 decides the chart the sample count calculated in S1205 to be the chart output count necessary for adjustment, updates and saves the sheet library information saved in the HDD 115, and ends the flow. In S1208, the CPU 114 decides the necessary chart output count to be the maximum value (i.e., around ten, which is the default value), updates and saves the sheet library information saved in the HDD 115, and ends the flow. Although description has been made in the present embodiment that control is made where the recommended chart output count for the next time is calculated each time multiple charts are output, this is not restrictive. Control may be performed where the recommended chart output count is decided by the flow illustrated in FIG. 12 just once after sheet registration.

According to this control, the number of adjustment charts output can be suppressed while suppressing variability in printing position misalignment due to variability in cutting of the sheets. Thus, unnecessary consumption of sheets and toner can be suppressed, and further the amount of time spent on printing position adjustment can be reduced.

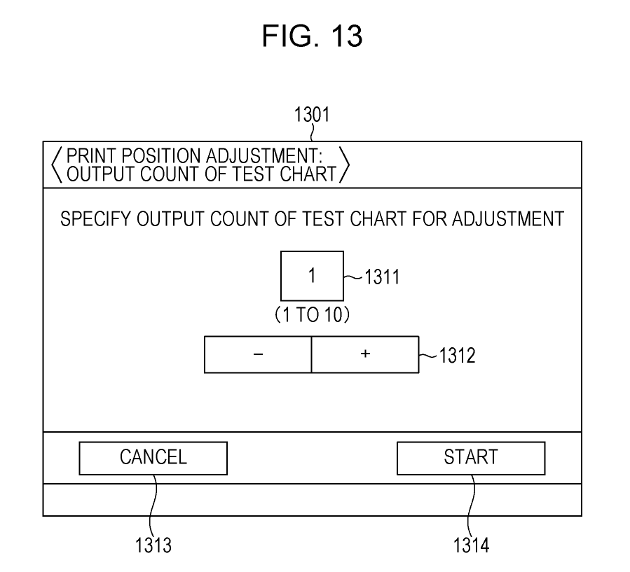

FIG. 13 is a schematic diagram illustrating an interface screen for an operator to select the number of charts for adjustment when performing printing position adjustment in the printing system. The number of charts for adjustment when performing printing position adjustment is automatically obtained from the sheet library information in the correction amount calculation flow in FIG. 9, but this is not restrictive. Control may be performed to display an output count selection screen 1301 for the operator to perform input each time, such as illustrated in FIG. 13.

The CPU 114 performs control to enable increase/decrease of the output count using an increase/decrease button 1312, and to change the display of an output count display region 1311 in FIG. 13. Control may be performed here to display a recommended chart output count, stored in the sheet library, as the count first displayed in the output count display region 1311.

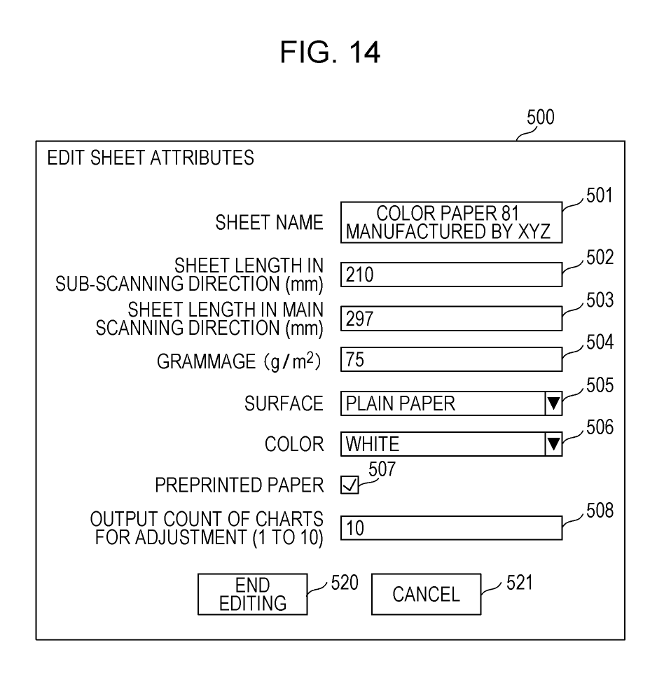

FIG. 14 is a schematic diagram illustrating an interface screen for an operator to edit sheet attributes. Although no region to input an output count of adjustment charts was provided in FIG. 5, a region 508 to input the adjustment chart output count may be provided, as illustrated in FIG. 14.

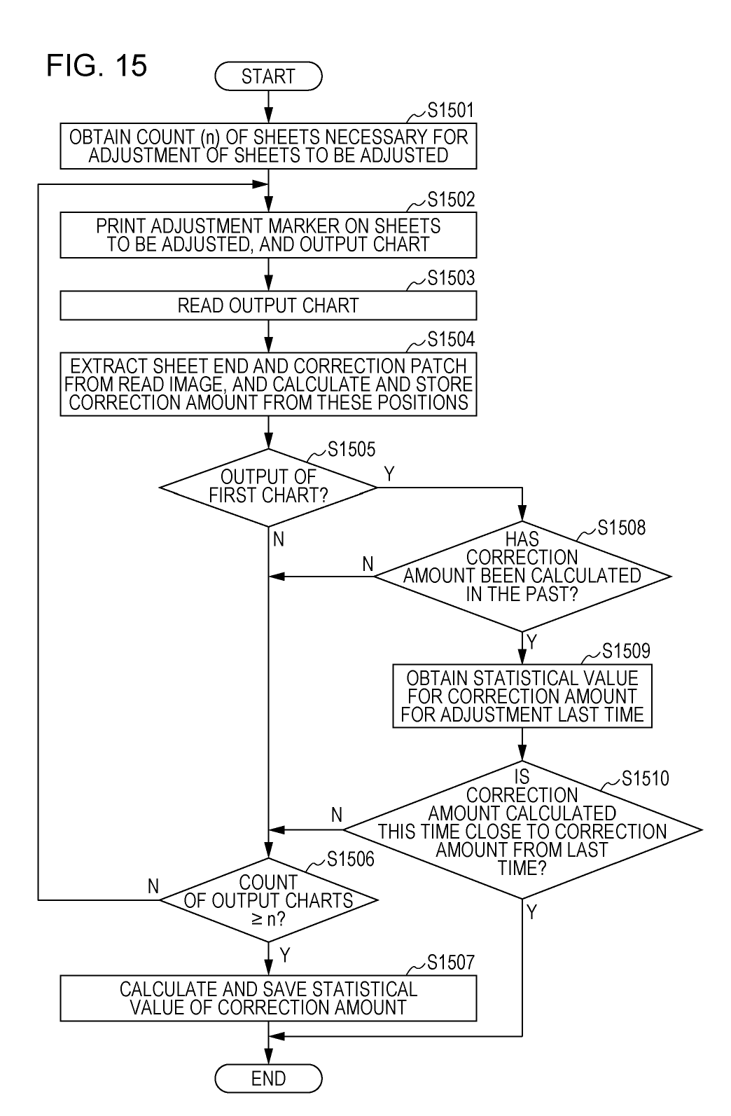

A modification of printing position adjustment performed by the CPU 114, to realize printing position adjustment for each sheet by the image forming apparatus, reading unit, and calculation method described in FIGS. 1 through 8, will be described in detail with reference to FIGS. 15 through 18. In the control in the steps of the flowcharts below, various types of operations are realized by the CPU 114 reading out and executing programs from the ROM 112. The operator selects one sheet from the interface screen 400 illustrated in FIG. 4 and presses the “adjust printing position” button 423 to start printing position adjustment.

S1501 through S1504 are the same control as S901 through S904, so description will be omitted. In S1505, the CPU 114 determines whether or not a chart read this time is a first chart, and if so, advances to S1508, but if a second or subsequent sheet, advances to S1506 and thereafter performs control that is the same as the control of the flow in FIG. 9. In S1508, the CPU 114 determines whether or not multiple charts have been output and correction amount calculated in the past. Specifically, the sheet library information saved in the HDD 115 is referenced, and if various types of data regarding correction amount in the past are stored, the flow advances to S1509, while if not, the flow advances to S1506. In S1509, the CPU 114 references the sheet library information saved in the HDD 115 and acquires various types of data regarding correction amount in the past, and the flow advances to S1510.

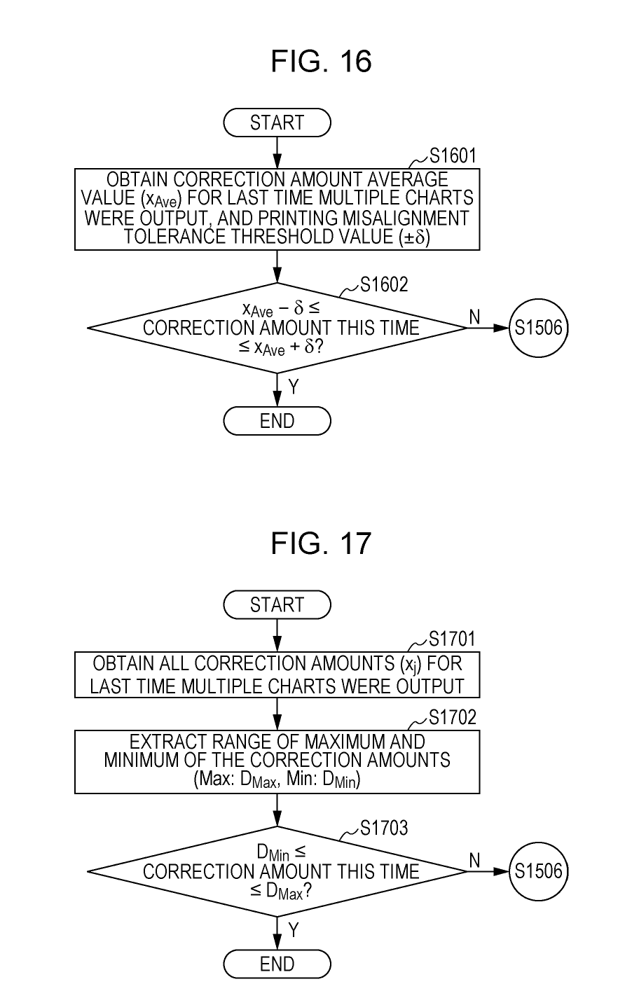

In S1510, the CPU 114 determines whether or not a difference between the printing position correction amount read this time and the correction amount the previous time is within a predetermined range. In a case where the difference in correction amounts is within the predetermined range in S1510, the CPU 114 skips the processing of acquiring the printing position misalignment amount and ends the flow. That is to say, the CPU 114 aborts printing position misalignment amount acquisition processing. On the other hand, in a case where the difference in correction amounts is not within the predetermined range in S1510, the CPU 114 advances to S1506, and continues the acquisition processing. The specific determination flow in S1509 and S1510 will be described in detail with reference to FIGS. 16 through 18. FIGS. 16 through 18 are each separate determination flows, any of which may be used for processing.

According to this control, even in a case where execution of printing position adjustment has been instructed, whether or not to continue detailed adjustment can be determined after one sheet, so unnecessary processing of outputting adjustment charts, reading, and correcting can be avoided. Thus, unnecessary consumption of sheets and toner can be suppressed, and further the amount of time spent on printing position adjustment can be reduced.

FIG. 16 illustrates an example of a specific determination flow in S1509 and S1510 in FIG. 15.

In S1601, the CPU 114 references the sheet library information saved in the HDD 115, acquires the average (X_{Ave}) of correction amounts from when correction was performed using the multiple charts the previous time, and the threshold value (±δ) of tolerable printing position misalignment, and advances to S1602. The threshold value in the present embodiment is set assuming a system where a range (±δ (e.g., 0.5 millimeters)) that ensures the printing position precision of the image forming apparatus is stored in the HDD 115 as the range of error, but this is not restrictive. For example, a configuration may be made where the operator can input a range of error that is tolerable from an interface unit. Further, a configuration may be made where this threshold value is not only held as a unique value for the device, but also can be stored beforehand for each sheet type, or input by the operator. In S1602, the CPU 114 determines whether or not the correction amount calculated from the chart read this time is within the range of the threshold value (±δ) of the average (x_{Ave}) from when correction was performed using the multiple charts the previous time. If within the range of the threshold value, determination is made that there is no need to execute printing position adjustment and update the printing position adjustment amount, and the flow ends. If not within the range of the threshold value, determination is made that there is need to re-execute printing position adjustment, and the flow advances to S1506.

FIG. 17 illustrates an example of a specific determination flow in S1509 and S1510 in FIG. 15.

In S1701, the CPU 114 references the sheet library information saved in the HDD 115, acquires the correction amount (xⱼ, where j=1, 2, . . . , n) of the charts from when correction was performed the previous time using multiple charts, and advances to S1702. In S1702, the CPU 114 extracts the smallest value (D_{Min}) and the greatest value (D_{Max}) of the correction amounts of the charts that have been obtained in S1701, and advances to S1703. In S1703, the CPU 114 determines whether or not the correction amount calculated from the chart read this time is within the range of greatest and smallest values from when correction was performed the previous time using multiple charts. If within the range of greatest and smallest values, determination is made that there is no need to execute printing position adjustment and update the printing position adjustment amount, and the flow ends. If not within the range of greatest and smallest values, determination is made that there is need to re-execute printing position adjustment, and the flow advances to S1506.

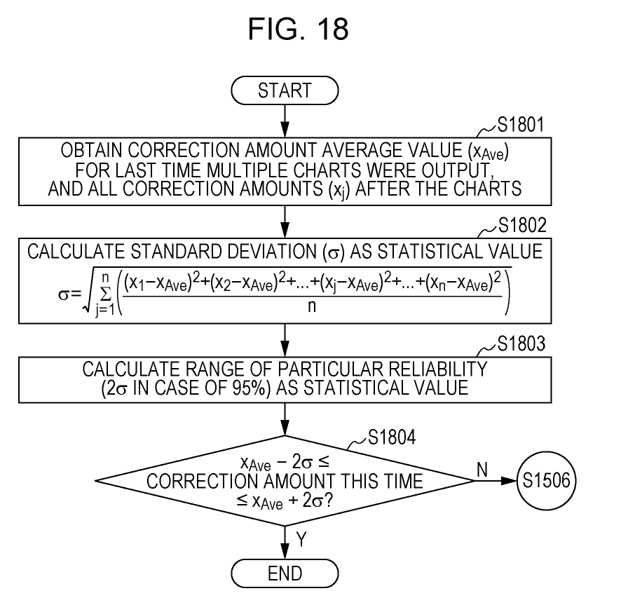

FIG. 18 illustrates an example of a specific determination flow in S1509 and S1510 in FIG. 15. In S1801, the CPU 114 references the sheet library information saved in the HDD 115, acquires the average (x_{Ave}) of correction amounts from when correction was performed using the multiple charts the previous time, and correction amount (xⱼ, where j=1, 2, . . . , n) of the charts, and advances to S1802. In S1802, the CPU 114 uses the following Expression (4) to calculate standard deviation (σ) as a statistical value, and advances to S1803.

$$σ = \sqrt{{\sum }_{j = 1}^{n} ( \frac{\begin{matrix}{( {x}_{1} - {x}_{Ave} )}^{2} + {( {x}_{2} - {x}_{Ave} )}^{2} + … + \\ {( {x}_{j} - {x}_{Ave} )}^{2} + … + {( {x}_{n} - {x}_{Ave} )}^{2}\end{matrix}}{n} )} \qquad ( 4 )$$

In S1803, the CPU 114 calculates the range of a particular reliability (2σ in the case of 95% reliability) as a statistical value, and advances to S1804. In S1804, the CPU 114 determines whether or not the correction amount calculated from the chart read this time is within the range of distribution of the particular reliability (e.g., 95% reliability→2σ) from when correction was performed the previous time using multiple charts. If within the range of the particular reliability, determination is made that there is no need to execute printing position adjustment and update the printing position adjustment amount, and the flow ends. If outside of the range of maximum or minimum values, determination is made that there is need to re-execute printing position adjustment, and the flow advances to S1506.

Thus, the CPU 114 decides the average value of printing position misalignment amounts based on results of reading multiple test sheets, obtains a greatest misalignment amount from printing position misalignment amounts of multiple test sheets, and if the greatest misalignment amount is smaller than a threshold value, reduces the recommended count. On the other hand, if the greatest misalignment amount is greater than the threshold value, the CPU 114 sets the recommended count to a predetermined number. According to embodiments of the present invention, cutting error of sheets can be obtained from reading results of test charts, and in a case where the cutting error is minute, the number of test chart output count can be reduced to suppress consumption of sheets. Further, the test chart output count is reduced according to embodiments of the present invention, so downtime due to printing position adjustment being performed can also be suppressed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-004549 filed Jan. 13, 2017, which is hereby incorporated by reference herein in its entirety.

What is claimed is:

1. An image forming apparatus, comprising:
an image forming unit configured to form an image on a sheet;
memory configured to store adjustment conditions for adjusting an image formation position by the image forming unit, as to the sheet; and
a controller configured to:
control the image forming unit to form a test image on a plurality of sheets;
acquire data relating to the test image formed on the plurality of sheets by the image forming unit; and
generate the adjustment conditions based on the data,
wherein the test image is used to detect misalignment of images to be formed on the plurality of sheets, and
wherein the controller controls a count of the plurality of sheets, based on data used in the past to generate adjustment conditions corresponding to the plurality of sheets.

2. The image forming apparatus according to claim 1,
wherein the memory stores the adjustment conditions corresponding to types of the sheets, and
wherein the type of the plurality of sheets corresponds to a type of a sheet that has been selected.

3. The image forming apparatus according to claim 1, further comprising:
a plurality of sheet containers configured to store the sheets,
wherein the memory stores the adjustment conditions corresponding to the sheet containers storing the sheets, and
wherein the sheet container where the plurality of sheets are stored corresponds to a sheet container where a sheet that has been selected is stored.

4. The image forming apparatus according to claim 1,
wherein the controller controls whether or not to reduce the count of the plurality of sheets, based on the data used in the past to generate the adjustment conditions corresponding to the plurality of sheets.

5. The image forming apparatus according to claim 1, further comprising:
a reception unit configured to receive user information indicating a count of the plurality of sheets,
wherein the controller controls whether or not to change the count of the plurality of sheets to another count that is smaller than the count indicated by the user information, based on the data used in the past to generate the adjustment conditions corresponding to the plurality of sheets.

6. The image forming apparatus according to claim 1, further comprising:
a conveyance unit configured to convey a sheet on which the test image has been formed along a conveyance path; and
a reading unit that is provided on the conveyance path and is configured to read the test image,
wherein the controller:
controls the conveyance unit to convey the plurality of sheets on which the test image has been formed;
controls the reading unit to read the test image; and
acquires the data based on results of reading the test image.

7. The image forming apparatus according to claim 1,
wherein the data includes a length from each of the edges of the plurality of sheets to the test image, and
wherein the controller:
decides an average value based on the length relating to the test image formed a previous time by the image forming unit; and
controls a count of the plurality of sheets based on a difference between the average value and the length relating to the test image formed the previous time by the image forming unit.

8. The image forming apparatus according to claim 1,
wherein the data includes a length from each of the edges of the plurality of sheets to the test image,
wherein the controller decides an average value based on the length relating to the test image formed a previous time by the image forming unit, and
wherein the controller reduces the count of the plurality of sheets in a case where a difference between the average value and the length relating to the test image formed the previous time by the image forming unit is smaller than a threshold value.

9. The image forming apparatus according to claim 1,
wherein the data includes a length from each of the edges of the plurality of sheets to the test image,
wherein the controller decides an average value based on the length relating to the test image formed a previous time by the image forming unit, and
wherein the controller controls the count of the plurality of sheets to another count that is smaller than the count indicated by the user information, in a case where a difference between the average value and the length relating to the test image formed the previous time by the image forming unit is smaller than a threshold value.

10. The image forming apparatus according to claim 1,
wherein the data includes a length from each of the edges of the plurality of sheets to the test image, and
wherein the controller:
decides a statistical value based on the length relating to the test image formed a previous time by the image forming unit; and
controls the count of the plurality of sheets based on the statistical value.

11. The image forming apparatus according to claim 1,
wherein the controller:
controls the image forming unit to form a first test image on a first face of the plurality of sheets; and
controls the image forming unit to form a second test image on a second face of the plurality of sheets that differs from the first face, and
wherein the first and second test images are used to detect misalignment between a position of an image to be formed on the first face of the plurality of sheets and a position of an image to be formed on the second face of the plurality of sheets.

12. An image forming apparatus, comprising:
an image forming unit configured to form an image on a sheet;
memory configured to store adjustment conditions for adjusting an image formation position by the image forming unit, as to the sheet; and
a controller configured to:
control the image forming unit to form a test image on a plurality of sheets;
acquire data relating to the test image formed on the plurality of sheets by the image forming unit; and
generate the adjustment conditions based on the data,
wherein the test image is used to detect misalignment of images to be formed on the plurality of sheets, and
wherein the controller controls whether or not to skip acquisition of data this time, based on data relating to the test image formed on a predetermined sheet included in the plurality of sheets.

13. The image forming apparatus according to claim 12,
wherein the controller controls whether or not to skip acquisition of data this time, based on the data relating to the test image formed on the predetermined sheet, and data used previously to generate adjustment conditions corresponding to the plurality of sheets.

14. The image forming apparatus according to claim 12,
wherein the data includes a length from each of the edges of the plurality of sheets to the test image,
wherein the controller decides an average value based on the length relating to the test image formed a previous time by the image forming unit, and
wherein the controller skips acquisition of data this time in a case where a difference between the average value and the length relating to the test image formed the previous time by the image forming unit is smaller than a threshold value.

15. The image forming apparatus according to claim 12,
wherein the data includes a length from each of the edges of the plurality of sheets to the test image,
wherein the controller decides a statistical value based on the length relating to the test image formed a previous time by the image forming unit, and
wherein the controller skips acquisition of data this time if the statistical value is within a predetermined range.

16. The image forming apparatus according to claim 12,
wherein the memory stores the adjustment conditions corresponding to types of the sheets, and
wherein the type of the plurality of sheets corresponds to a type of a sheet that has been selected.

17. The image forming apparatus according to claim 12, further comprising:
a plurality of sheet containers configured to store the sheets,
wherein the memory stores the adjustment conditions corresponding to the sheet containers storing the sheets, and
wherein the sheet container where the plurality of sheets are stored corresponds to a sheet container where a sheet that has been selected is stored.

18. The image forming apparatus according to claim 12, further comprising:
a reception unit configured to receive user information indicating a count of the plurality of sheets,
wherein the controller decides the count of the plurality of sheets on which the test image is to be formed, based on the user information, and
wherein the controller controls the image forming unit to start forming the test image on the plurality of sheets, based on the decided count.

19. The image forming apparatus according to claim 12, further comprising:
a conveyance unit configured to convey a sheet on which the test image has been formed along a conveyance path; and
a reading unit that is provided on the conveyance path and is configured to read the test image,
wherein the controller:
controls the conveyance unit to convey the plurality of sheets on which the test image has been formed;
controls the reading unit to read the test image; and
acquires the data based on results of reading the test image.

20. The image forming apparatus according to claim 12,
wherein the controller:
controls the image forming unit to form a first test image on a first face of the plurality of sheets; and
controls the image forming unit to form a second test image on a second face of the plurality of sheets that differs from the first face, and
wherein the first and second test images are used to detect misalignment between a position of an image to be formed on the first face of the plurality of sheets and a position of an image to be formed on the second face of the plurality of sheets.
